(19) United States
(12) Patent Application Publication
(10) Pub. No.: US 2007/0214671 A1
(43) Pub. Date: Sep. 20, 2007

(54) Tearing Ruler

(76) Inventors: Amy Campagna, Oxford, CT (US); Mark Guarraia, Providence, RI (US); David Mathieu, Colchester, CT (US); Michael E Peterson, Fairfield, CT (US)

Correspondence Address: ALIX YALE & RISTAS LLP, 750 MAIN STREET, SUITE 1400, HARTFORD, CT, 06103, US

(21) Appl. No.: 11/547,876

(22) PCT Filed: Feb. 9, 2006
(86) PCT No.: PCT/US06/04490

§ 371 Date: Oct. 5, 2006

Related U.S. Application Data
(60) Provisional application No. 60/652,267, filed on Feb. 11, 2005.

(51) Int. Cl. B43L 7/00

(52) U.S. Cl. 33/492

(57) ABSTRACT

A ruler for craft applications has an efficient construction which employs a pair of tearing edges to facilitate tearing and a pair of measurement scales. The tearing ruler may be angularly oriented to facilitate either tearing or measurement activities. The tearing edges are defined by various waveform patterns. The tearing edges may be interchangeable.

### BACKGROUND OF THE INVENTION

This invention relates generally to rulers adapted for use in various craft applications. More particularly, the present invention relates to rulers which have a measurement scale as well as an extended non-linear tearing edge.

A number of rulers and devices have been developed to accomplish the multiple functions of providing a measuring scale as well as a tearing edge to facilitate the tearing of paper in a non-linear pattern such as to form a deckle edge. In certain crafts such as, for example, the customization of scrapbooks, it is highly desired to form non-linear edges. Such edge configurations which may have highly irregular shapes referred to herein as waveforms. These edges present the appearance of a handcrafted, non-linear, quasi-random type edging. Some known devices employ opposite edges having a peripheral profile of different configurations and also include linear measuring scales.

### SUMMARY OF THE INVENTION

Briefly stated, the invention in a preferred form is a ruler for craft applications which comprises an elongated multi-sided body having a pair of longitudinally extending transversely spaced tearing edges. A longitudinally extending upright extension defines opposing convergent sides and terminates in a vertex substantially equiangularly spaced from the tearing edges. A measuring scale is disposed on at least one of said sides. The tearing edges are defined by waveforms which are preferably different. A measuring scale is disposed on each of the sides. The extension has a spade-like shaped profile and a pair of longitudinal indentations are defined at opposed locations of the body.

The tearing edges may be formed on interchangeable members. An attachment member which defines one or both of the tearing edges is removably mounted to the base. The attachment member may be slidably received by the base and secured in a tongue and groove relationship. Alternatively, an attachment member which provides for interchangeable tearing edges has a plurality of lugs which snap into corresponding apertures of the base.

An object of the invention is to provide a new and improved ruler or measuring device which also includes a pair of non-linear tearing edges.

Another object of the invention is to provide a new and improved tearing ruler which may be efficiently and effectively used to provide an accurate measuring scale as well as a very efficient tearing edge.

Other objects and advantages of the invention will become apparent from the detailed description and the drawings.

### BRIEF DESCRIPTION OF THE DRAWINGS

FIG. 1 is a perspective view of a tearing ruler in accordance with the present invention;

FIG. 2 is a side view of the tearing ruler of FIG. 1;

FIG. 3 is an enlarged sectional view of the tearing ruler of FIG. 1 taken along the line 3-3 thereof;

FIGS. 4A, 4B and 4C are top plan views of various embodiments of a tearing ruler in accordance with the present invention;

FIG. 5 is an end view illustrating the tearing ruler of FIG. 1 on a paper surface preparatory to tearing the paper;

FIG. 6 is an enlarged schematic view illustrating how the ruler of FIG. 1 may be efficiently grasped and employed for tearing purposes;

FIG. 7 is an end view of the ruler of FIG. 1 at a preferred measuring angular orientation on a surface illustrating how the ruler may be effectively employed for measuring purposes;

FIG. 8 is an enlarged fragmentary top view of a tearing ruler in accordance with the present invention;

FIGS. 9A, 9B and 9C are fragmentary perspective views illustrating alternative embodiments of a tearing ruler with interchangeable blades in accordance with the present invention, wherein FIG. 9A illustrates the main body of the ruler, FIG. 9B illustrates a double-sided tearing blade attachment and FIG. 9C illustrates a single tearing blade attachment; and

FIGS. 10A, 10B and 10C are fragmentary perspective views illustrating additional embodiments of a tearing ruler with interchangeable blades, wherein FIG. 10A illustrates the main body of the ruler, FIG. 10B illustrates a single-sided tearing blade attachment and FIG. 10C illustrates a double sided tearing blade attachment.

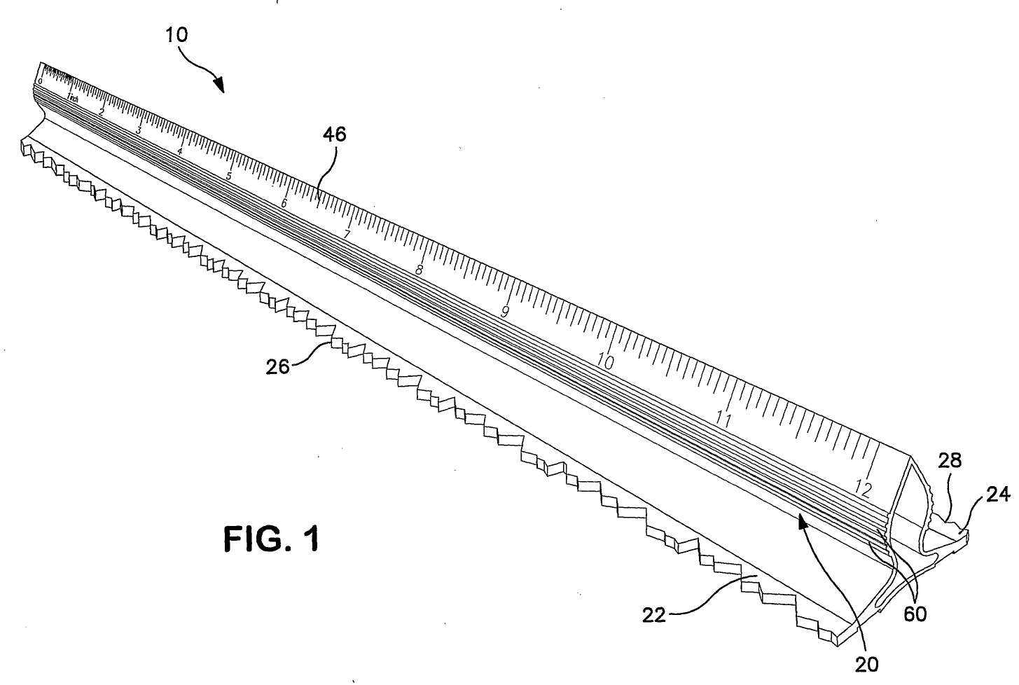

### DETAILED DESCRIPTION OF THE PREFERRED EMBODIMENTS

With reference to the drawings, wherein like numerals represent like parts throughout the several views, a tearing ruler in accordance with the present invention is generally designated by the numeral 10. The tearing ruler is a multi-function device which includes a pair of tearing edges and a pair of measuring scales as will be described below. The tearing ruler has numerous applications in connection with well known crafting activities such as scrapbook making.

The tearing ruler 10 in a preferred embodiment includes an elongated body 20 which may be one foot in length or other suitable length and is in one embodiment manufactured from plastic material. In a preferred form, the ruler is a hollow member having a substantially uniform thickness, although the ruler may also have a solid configuration. The ruler may also be manufactured from aluminum, titanium or other suitable materials.

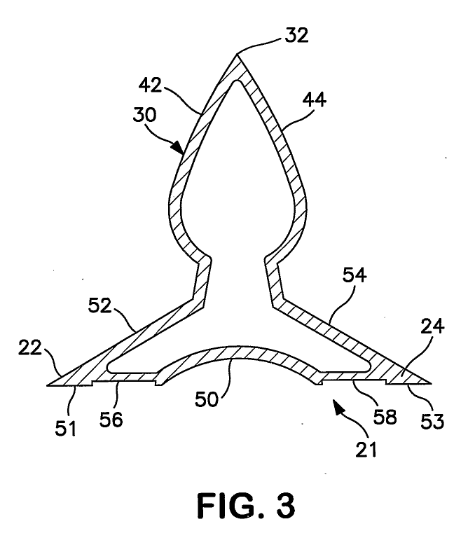

The ruler 10 may best be appreciated by reference to FIG. 3 which illustrates the multi-sided geometry principally defined by a base 21 having opposed tearing edges 22 and 24 and an upright, shoulder-like extension 30 which has a spade-like profile and converges to a vertex point 32.

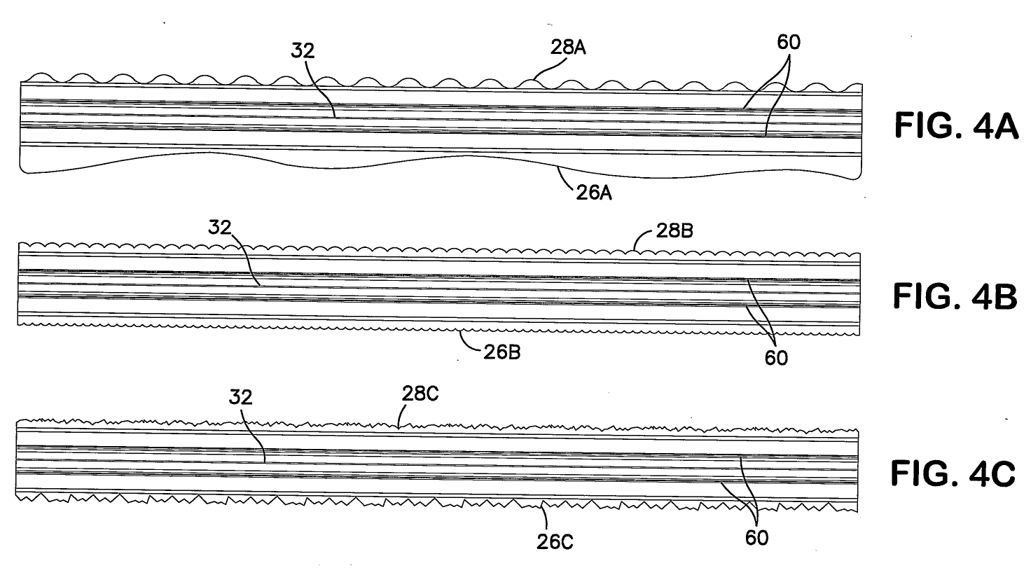

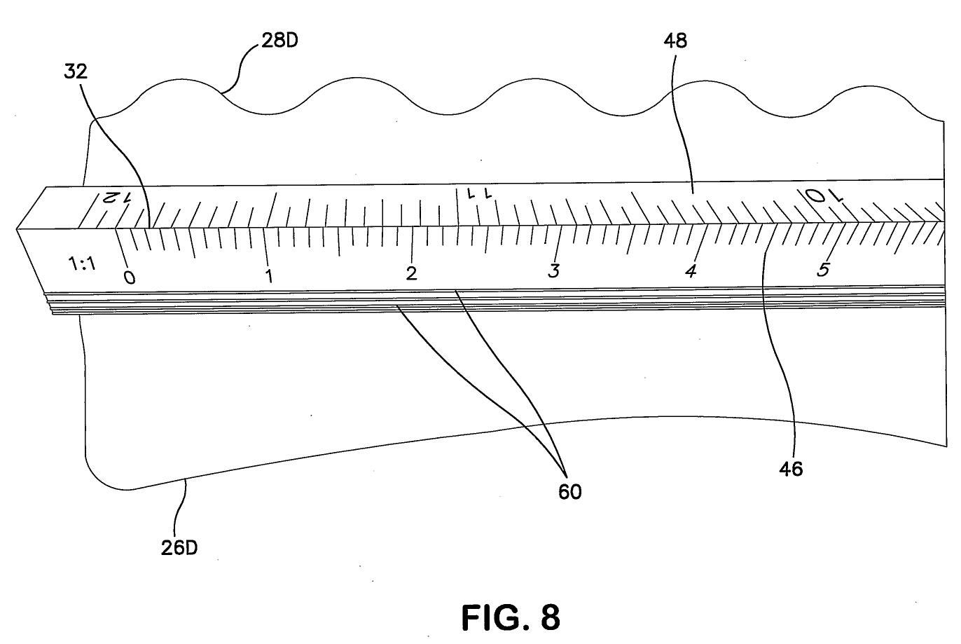

Each of the tearing edges 22 and 24 are respectively peripherally defined by longitudinally extending waveform patterns 26 and 28, respectively. The waveform patterns are preferably non-identical, non-linear and irregular in nature. In some embodiments, the patterns are configured to produce a deckle edge. The tearing edges may assume a wide variety of forms such as the waveform patterns 26A, 26B, 26C, 28A, 28B, and 28C illustrated in FIGS. 4A-4C and waveform patterns 26D and 28D of FIG. 8 wherein one pattern has more closely spaced inward tear segments and the other pattern has a more gradual tear contoured pattern. Naturally, various patterns of a number of wide variety of forms such as sharply jagged, zig-zag and repeating and non-repeating, non-linear patterns, all of which are referred to as waveforms, may be employed.

With reference to FIG. 3, the underside of the ruler base 21 adjacent each of the tearing surfaces is defined by longitudinally extending panel sides 51 and 52 and 53 and 54 which converge at substantially 30° angles. The tearing edges 22, 24 in preferred embodiments integrally extend from the converging vertex-like locations. Sides 51 and 53 have uniform widths, are coplanar and are medially connected by an arcuate longitudinally extending channel portion 50 to form a stable support base. In addition, longitudinally extending, transversely spaced recesses 56 and 58 traverse the sides 51 and 53 to provide a non-slip underside surface for the bases.

The shoulder extension 30 has an axially symmetric spade-like shape. The extension 30 integrally extends from the oblique sides 52 and 54 to upwardly terminate at vertex 32 via convergent sides 42 and 44 which have a substantially linear planar portion. In a preferred form, panel side 42 is affixed with an English measurement scale 46 and the panel side 44 is affixed with a metric measurement scale 48. The indicia graduations preferably extend toward the vertex point 32 as best illustrated in FIG. 8. The scales preferably have a central 0 and form a zero centering scale.

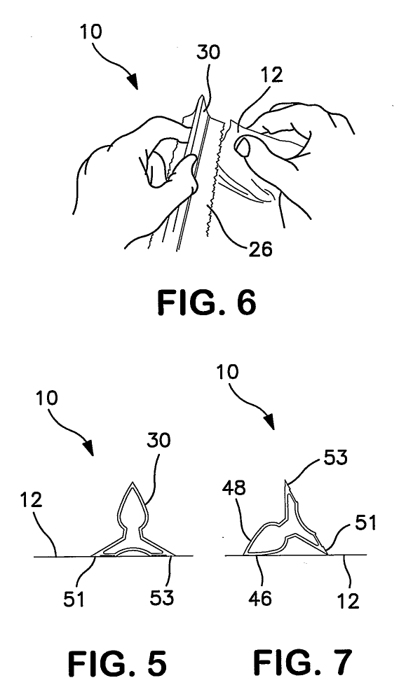

As best illustrated in FIGS. 5 and 6, for tearing or tearing applications, the ruler rests against the surface of the paper 12 to be torn so that the coplanar base sides 51 and 53 engage the top surface of the paper 12. The paper may be easily cut or torn by manually pressing down through the extension as illustrated in FIG. 6 and upwardly pulling the paper to sever a portion of same along the selected tearing edge.

The ruler 10 may also be efficiently used as a measuring scale by positioning the measuring scale (46 in FIG. 7 illustration) not to be used against the surface of the paper or other material so that the tearing edge rests in the stable configuration illustrated in FIG. 7. In this fashion, the selected measuring scale 48 may be quite closely positioned along the paper and a precise measurement can be readily accomplished.

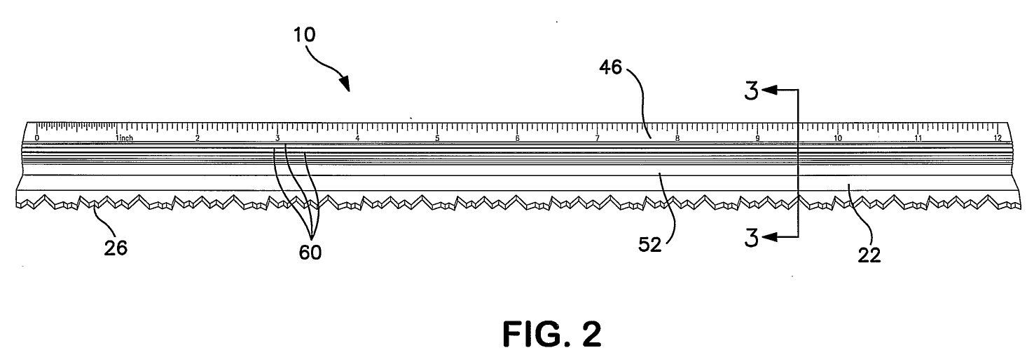

In some embodiments such as illustrated in FIGS. 2 and 8, several parallel ribs 60 traverse the longitudinal extent of the ruler to facilitate the gripping and use of the ruler for tearing purposes.

In addition, a pair of indentations 70 and 72 at opposing sides of the extension adjacent sides 52 and 54 respectively are provided to facilitate the grasping and use of the ruler with the fingers.

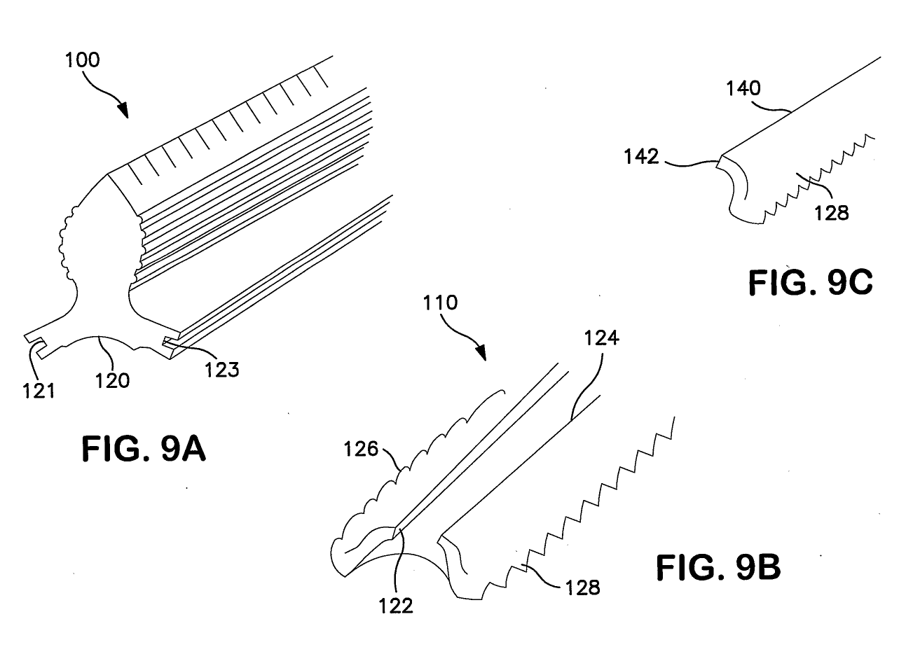

With reference to FIGS. 9A, 9B and 9C, a tearing ruler which employs interchangeable tearing blades is generally designated by the numeral 100. The ruler 100 is similar in form and function to the previously described tearing ruler 10, except for the base/tearing edge features. The base portion 120 includes at transversely opposite edge portions longitudinally extending blade slots 121 and 123. A double-sided interchangeable blade attachment 110 is adapted to slidably mount onto the main body. The attachment 110 includes a pair of opposed, inwardly protruding tracks 122 and 124 which mate with the respective blade slots 121 and 123 in a tongue and groove fashion. The attachment 110 includes transversely spaced tearing edge patterns in the form of waveforms 126 and 128 which may be similar in form and function to the tearing edge waveforms 26 and 28, as previously described. The interchangeable blade attachment 110 has a length commensurate with the length of the ruler body. Alternatively, the interchangeable tearing edges may each be provided by means of a single sided blade attachment 140 having a single tearing edge 141 and having a single track 142 which mounts into the blade slot 123 as illustrated in FIG. 9C.

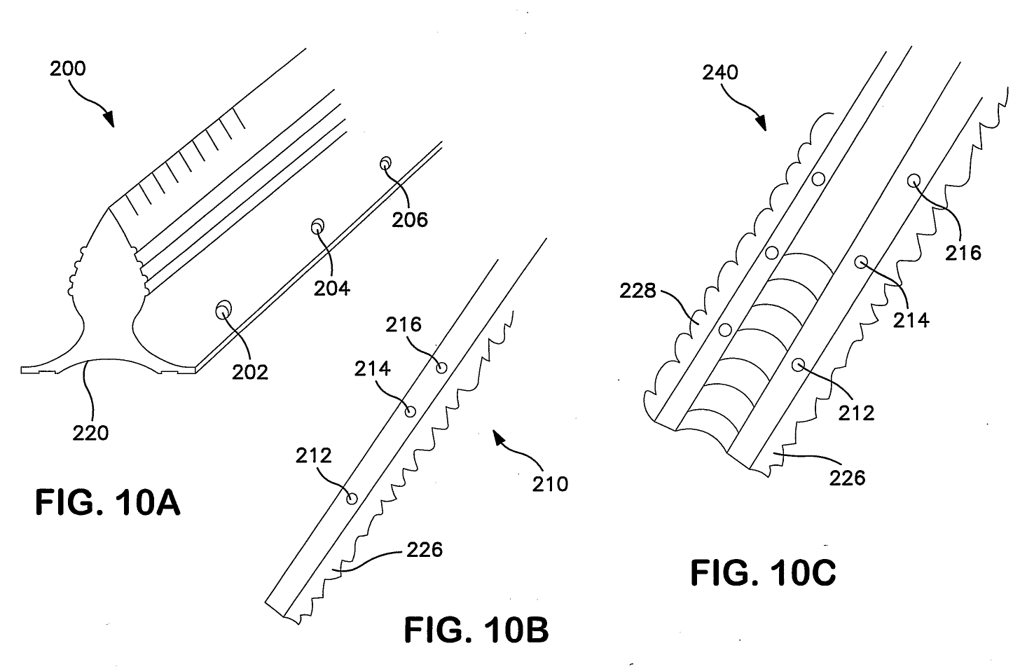

FIGS. 10A, 10B and 10C illustrate another embodiment of a tearing ruler with interchangeable tearing blades which is designated generally by the numeral 200. The tearing ruler 200 includes a plurality of longitudinally spaced apertures 202, 204, 206, etc., in the bottom base portion of the body 220. A single sided blade attachment 210 includes projecting lugs 212, 214, 216 which align and snap into the corresponding apertures to secure the blade attachment 210 to the main body 220. The blade attachment peripherally defines a waveform pattern 226 which may be similar in form and function as those previously described. Alternatively, as illustrated in FIG. 10C, a double-edged snap-type blade attachment 240 includes opposing tearing edges defined by various waveform patterns 226 and 228. Transversely spaced strips of longitudinally spaced lugs snap into respective apertures at the underside of the main body.

Multiple interchangeable attachments which incorporate various tearing edge configurations are provided in addition to the attachments 110, 140, 210 and 240. It should be appreciated that the tearing rulers 100 and 200 provide a means wherein a single ruler body may be employed with multiple interchangeable blades so that if a different tearing pattern is desired, the tearing edge or edges may be removed and selectively replaced by a suitable tearing blade.

While preferred embodiments of the foregoing invention have been set forth for purposes of illustration, the foregoing description should not be deemed a limitation of the invention herein. Accordingly, various modifications, adaptations and alternatives may occur to one skilled in the art without departing from the spirit and scope of the present invention.

What is claimed:

1. A ruler for craft applications comprising:
an elongated multi-sided body having a pair of longitudinally extending transversely spaced tearing edges;
a longitudinally extending upright extension defining opposed convergent sides and terminating in a vertex substantially equiangularly spaced from said edges; and
a measuring scale disposed on at least one of said sides.

2. The ruler of claim 1, wherein each of said tearing edges is defined by a waveform.

3. The ruler of claim 2, wherein the waveforms are different.

4. The ruler of claim 1 comprising a measuring scale on each of said sides.

5. The ruler of claim 4, wherein one scale is a metric scale and the other scale is an English unit scale.

6. The ruler of claim 1, wherein a pair of longitudinal indentations is defined at opposed locations of said body.

7. The ruler of claim 1, wherein said sides have planar portions, each of which is substantially co-planar with peripheral portions of a tearing edge.

8. The ruler of claim 1, wherein said extension has a spade-like shaped profile.

9. The ruler of claim 1, wherein said tearing edges are formed on interchangeable members.

10. A ruler for craft applications comprising:
an elongated body substantially defining three vertices;
a pair of transversely spaced tearing edges disposed at two of said vertices;
a pair of sides converging to form the third vertex; and
a measuring scale disposed on each of said sides.

11. The ruler of claim 10, wherein each of said tearing edges has a distinct waveform pattern.

12. The ruler of claim 10, wherein said body has a base defined by a planar support surface and a spade-like shaped portion.

13. The ruler of claim 10, wherein said tearing edges are portions of members which are removably mountable to said body.

14. A ruler for craft applications comprising:
an elongated body having opposed sides and having a base which transversely extends from each of said sides;
an upright shoulder extending upwardly relative to said base and having a pair of opposed surfaces;
a measuring scale affixed to each of said surfaces; and
first and second tearing edges each disposed at transversely opposite locations of said base.

15. The ruler of claim 14, further comprising an attachment member defining said first and second tearing edges and removably mountable to said base.

16. The ruler of claim 14, further comprising an, attachment member defining said first tearing edge and removably mountable to said base.

17. The ruler of claim 15, wherein said attachment member is slidably received by said base.

18. The ruler of claim 16, wherein said attachment member has a track and said base has a slot for securing said attachment member to said base in a tongue and groove relationship.

19. The ruler of claim 15, wherein said attachment member has a plurality of lugs which snap into corresponding apertures of said base.

20. The ruler of claim 16, wherein said attachment member is mounted to said base by a snap-type engagement.
